(19) United States
(12) Patent Application Publication
(10) Pub. No.: US 2012/0049037 A1
(43) Pub. Date: Mar. 1, 2012

(54) CONNECTING APPARATUS

(75) Inventors: WEN-SHENG CHEN, Shenzhen City (CN); HAI-BO ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/975,719

(22) Filed: Dec. 22, 2010

(30) Foreign Application Priority Data
Aug. 25, 2010 (CN) 201010262469.4

(51) Int. Cl. B25J 17/02; F16M 13/02

(52) U.S. Cl. 248/550; 901/29

(57) ABSTRACT

A connecting apparatus for a robot arm and effector includes a mounting member and a carrier connected to the robot arm and the effector, respectively. The mounting member includes a support body, and the carrier is slidable relative to the mounting member. The connecting apparatus further includes at least one bumper assembly positioned between the support body and the carrier to absorb impact energy; and a detection module generating a signal to stop the robot arm when the carrier is moved to a predetermined position relative to the mounting member.

### BACKGROUND

1. Technical Field

The present disclosure generally relates to robotics, and particularly to a connecting apparatus for a robot arm and an effector.

2. Description of Related Art

During a manufacturing process, such as labeling, a robot arm and an effector manipulating a workpiece may be employed. The effector may be a suction unit or clamp. Typically, the effector and an end of the robot arm are rigidly connected together. However, when the effector is moved to a predetermined position rapidly, if the workpiece carried by the effector is impacted by an external force, the force applied may be transmitted to the robot arm resulting in damage thereof.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an embodiment of a connecting apparatus for a robot arm and an effector.

FIG. 2 is an exploded, isometric view of the connecting apparatus of FIG. 1.

### DETAILED DESCRIPTION

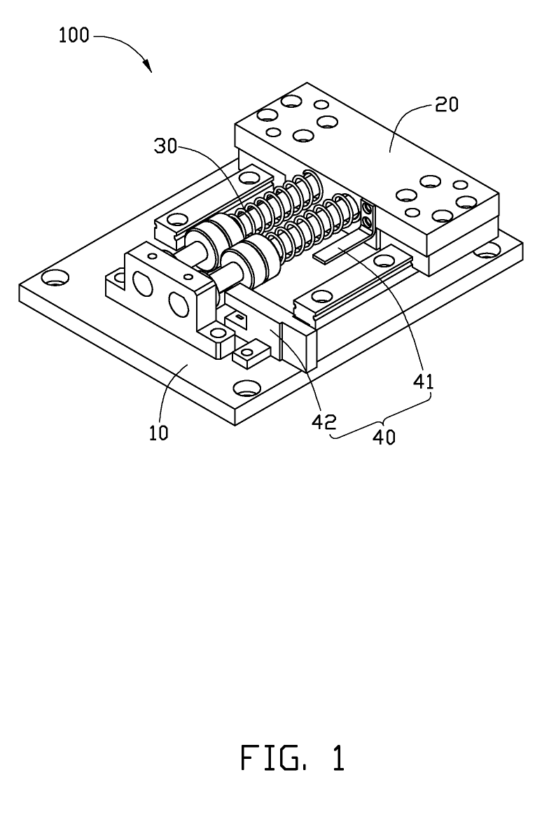

Referring to FIG. 1, one embodiment of a connecting apparatus 100 connects a robot arm and one or more suction units and also protects the suction units and workpieces carried by the suction units from damage by impact. The connecting apparatus 100 includes a mounting member 10, a carrier 20 slidable relative to the mounting member 10, two bumper assemblies 30, and a detection module 40. In this embodiment, the mounting member 10 is fixed to a robot arm (not shown), and the carrier 20 is connected to the suction units (not shown).

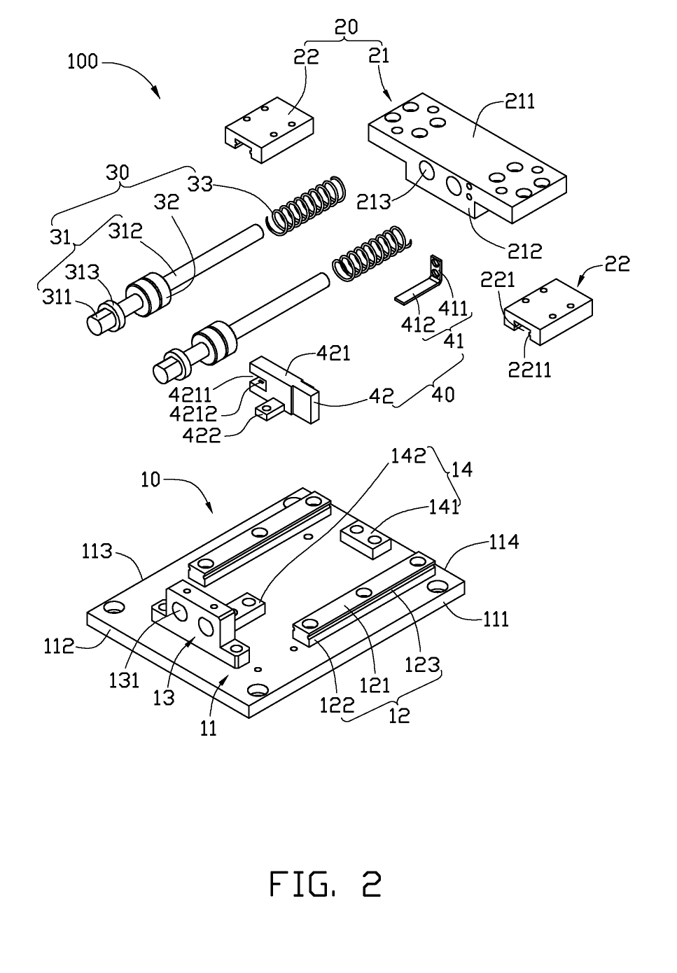

Referring also to FIG. 2, the mounting member 10 includes a base 11, two substantially parallel guide rails 12 extending on the base 11, a support body 13, and a stopper 14 mounted on the base 11.

The base 11 can be substantially rectangular and includes a first sidewall 111, a second sidewall 112, a third sidewall 113, and a fourth sidewall 114 connected in order. The two guide rails 12 are arranged adjacent to the first sidewall 111 and the third sidewall 113, respectively. Each guide rail 12 is a longitudinal substantially rectangular strip, and includes a top surface 121 away from the base 11 and two opposite sidewalls 122 connected to the top surface 121. Each sidewall 122 defines a guiding groove 123 extending through opposite ends of the guide rail 12.

The support body 13 is positioned adjacent to one end of the guide rail 12 to support the bumper assemblies 30. In the illustrated embodiment, the support body 13 defines two shaft holes 131 to mount the bumper assemblies 30.

The stopper 14 includes a first stopper block 141 and a second stopper block 142 positioned on opposite ends of the guide rails 12. The first and second stopper blocks 141, 142 are positioned between the guide rails 12 to cooperatively limit the range of motion of the carrier 20.

The carrier 20 is arranged adjacent to the fourth sidewall 114 and includes a main body 21 and two sliding members 22 fixed to opposite sides of the main body 21. The main body 21 is substantially T-shaped and has a top surface 211 and a sidewall 212 connected to the top surface 211. The sidewall 212 defines two guide holes 213 having a substantially circular cross section. Each sliding member 22 is substantially U-shaped and defines a sliding groove 221 on a bottom surface. Opposite inner surfaces of the sliding groove 221 form a protrusion 2211 slidably received in the corresponding guiding groove 123, thus slidably connecting the carrier 20 and the guide rails 12.

Each bumper assembly 30 includes a guide bar 31 having a threaded segment (not shown), two threaded retainers 32 threaded on the threaded segment 32 and interlocked, and an elastic member 33 between and abutting the threaded retainer 32 and the main body 21.

The guide bar 31 further includes a connecting portion 311, a guide portion 312 slidably received in the corresponding guide hole 213, and a flange 313 between the connecting portion 311 and the guide portion 312. The threaded segment of the guide bar 31 is formed on the connecting portion 311. The connecting portion 311 has a non-circular cross section corresponding to the shaft hole 131 of the support body 13, such that the connecting portion 311 is non-rotatably connected to the support body 13 with the flange 313 contacting the support body 13. The guide portion 312 has a substantially circular cross section and is received in the corresponding guide hole 213 of the carrier 20. In the illustrated embodiment, the elastic member 33 is a spring and wound around the guide portion 312.

The detection module 40 can utilize a contact trigger or a light trigger detection module. In this embodiment, the detection module 40 includes a trigger member 41 fixed to the carrier 20 and a detection member 42 mounted on the base 11. The trigger member 41 is a substantially L-shaped metal sheet and includes a fixing portion 411 secured to the carrier 20 and a trigger portion 412 extending from the fixing portion 411. The detection member 42 includes a main body 421 and a fixing member 422 connecting the main body 421 and the base 11. One side surface of the main body 421 defines a receiving groove 4211 for the trigger member 41. A trigger point 4212 is positioned on the inner surface of the receiving groove 4211. The top surface of the groove 4211 can prevent the other components from contacting the trigger point 4212 and impairing operation.

In use, when the suction units mounted on the carrier 20 or the workpieces carried by the suction unit are impacted by external force, the carrier 20 is moved toward the second stopper block 412, thereby compressing the elastic member 33 and absorbing the impact energy. The trigger member 41 is moved together with the carrier 20. When the carrier 20 is moved to a predetermined position where the impact force applied on the carrier 20 exceeds a predetermined range, the trigger portion 412 is moved into the receiving groove 4211 and contacts the trigger point 4212. The detection module 40 generates a stop signal to a controller to stop the robot arm, preventing the suction units, workpieces, and/or the robot arm from being damaged. When impact force is within the predetermined range, the elastic member 30 absorbs the impact energy, thus preventing damage caused by collision. Even if the controller cannot stop the robot arm occasionally, in response to the stop signal, the second stopper block 142 provides further protection. By adjusting the threaded retainers 32 in an axial position of the guide bar 31, the compression of the elastic member 30 can be adjusted, thus fitting various applications.

It should be understood that in other embodiments, one, three, or more bumper assemblies 30 can be applied. Each bumper assembly 30 can have only one threaded retainer 33.

It is believed that the present embodiments and their advantages will be understood from the foregoing description, and it will be apparent that various changes may be made thereto without departing from the spirit and scope of the disclosure or sacrificing all of its material advantages.

1. A connecting apparatus for connecting a robot arm and an effector, the connecting apparatus comprising:
a mounting member connectable to the robot arm and a carrier connectable to the effector, the mounting member comprising a support body, and the carrier being slidable relative to the mounting member;
at least one bumper assembly positioned between the support body and the carrier to absorb impact energy; and
a detection module generating a signal to stop the robot arm when the carrier is moved to a predetermined position relative to the mounting member.

2. The connecting apparatus of claim 1, wherein the mounting member further comprises a base and at least one guide rail extending on the base, and the carrier comprises a main body and at least one sliding member slidably engaging with the at least one guide rail.

3. The connecting apparatus of claim 2, wherein the at least one sliding member defines a sliding groove, the sliding groove forms a protrusion on opposite inner surfaces thereof, the at least one guide rail comprises opposite sidewalls, each sidewall defines a guiding groove extending through opposite ends of the at least one guide rail, and the protrusion is slidably received in the guiding groove.

4. The connecting apparatus of claim 1, wherein the at least one bumper assembly comprises a guide bar having a threaded segment, a threaded retainer engaging with the threaded segment, and an elastic member positioned between and abutting the threaded retainer and the carrier.

5. The connecting apparatus of claim 4, wherein the guide bar comprises a connecting portion fixed with the mounting base, a guide portion slidably connected to the carrier, and a flange positioned between the connecting portion and the guide portion to contact the support body.

6. The connecting apparatus of claim 4, wherein the elastic member is a spring and positioned around the guide portion.

7. The connecting apparatus of claim 5, wherein the connecting portion has a non-circular cross section, and the support body defines a shaft hole to non-ratably receive the connecting portion.

8. The connecting apparatus of claim 1, wherein the detection module comprises a trigger member fixed to the carrier, a detection member mounted on the mounting member, and a trigger point; the detection member defines a receiving groove to accept the trigger member, and the trigger point is positioned on an inner surface of the receiving groove.

9. The connecting apparatus of claim 8, wherein the trigger member is an L-shaped metal sheet and comprises a fixing portion secured to the carrier and a trigger portion extending from the fixing portion to contact the trigger point.

10. The connecting apparatus of claim 1, further comprising a first stopper block and a second stopper block positioned on opposite ends of the at least one guide rail, and the first and second stopper blocks cooperatively limit the range of motion of the carrier.

11. The connecting apparatus of claim 10, wherein the mounting member further comprises a base and at least one guide rail extending on the base, and the at least one guide rail comprises two substantially parallel guide rails, and the first and second stopper blocks are positioned between the guide rails.
